(19) United States
(12) Patent Application Publication
(10) Pub. No.: US 2002/0066790 A1
(43) Pub. Date: Jun. 6, 2002

(54) Device, system and method for conducting a transaction using a translucent, transparent or semitransparent transaction card

(76) Inventor: Mikael Cocco, New York, NY (US)

Correspondence Address: KILPATRICK STOCKTON LLP, 607 14TH STREET, N.W., SUITE 900, WASHINGTON, DC, 20005, US

(21) Appl. No.: 09/729,261

(22) Filed: Dec. 1, 2000

Related U.S. Application Data
(60) Provisional application No. 60/168,894, filed on Dec. 3, 1999.

(51) Int. Cl. G06K 19/06

(52) U.S. Cl. 235/491

(57) ABSTRACT

A device, system, and method for performing a transaction using a translucent, transparent or semitransparent transaction card with a transaction card sensing device includes a transaction card of a material capable of passing visible light, such as clear PVC, and an infrared filter which is capable of passing visible light while preventing passage of infrared light in a predetermined range of wavelengths emitted by an infrared light source of the transaction card sensing device. When the transaction card is dipped in the card sensing device, the infrared light filter interrupts the passage of infrared light from the infrared light emitting source to an infrared light sensor of the transaction card sensing device, and the infrared light sensor generates a signal indicative of the presence of the transaction card in the card sensing device in response to the interruption.

### PRIORITY APPLICATION

This application claims the benefit of U.S. Provisional Application No. 60/168,894 filed Dec. 3, 1999, and entitled “Device, System And Method For Conducting A Transaction Using A Translucent, Transparent Or Semitransparent Transaction Card,” incorporated here by this reference.

### FIELD OF THE INVENTION

The present invention relates generally to the field of financial transaction cards and more particularly to a device, system and method for conducting a transaction, such as a financial transaction, using a translucent, transparent or semitransparent transaction card, such as a magnetic stripe card or microchip embedded smart card.

### BACKGROUND OF THE INVENTION

For many years the transaction card industry has relied upon a transaction card, such as a credit card or debit card, made of certain materials and according to a certain specification range. That material is basically comprised of a white core of polyvinyl chloride plastic (PVC), with a surface which can be printed with text and/or graphics. The card is then overlaid front and back with a thin mil of transparent or clear PVC which sandwiches the card. After overlaying the card, certain finishing work is performed on the card to turn it into a transactable product for use, for example, at a card reading or device, such as an automatic teller machine (ATM).

Currently, a transaction card issuer who would prefer the uniqueness of a translucent, transparent or semitransparent transaction card is unable to issue such a card because of certain obstacles. For example, in order for the presence of a transaction card to be recognized by a sensing device, for example, of an ATM, the card must absorb or block certain wavelengths of infrared light. Presently, that requirement prevents transaction card designers and issuers from manufacturing and issuing translucent or transparent transaction cards.

The purpose of the absorption or blocking of certain wavelengths of infrared light is to make the presence of the transaction card known to an electronic device into which the card is inserted in order to perform a transaction. The absorption or blocking of certain wavelengths of infrared light by the transaction card enables the electronic device to sense the presence of the card and go forward with the transaction. Thus, while a transaction card, such as a conventional magnetic stripe card or a smart card, depends at least in part on the presence of the magnetic stripe or embedded microchip for its functionality, it also depends at least in part on the infrared light absorption or blocking property provided by the white PVC core for its functionality.

### SUMMARY OF THE INVENTION

It is a feature and advantage of the present invention to provide a device, system and method for conducting a transaction using a transaction card, such as a magnetic stripe card or smart card, which is translucent, transparent or semitransparent to visible light, but which absorbs or blocks certain wavelengths of infrared light.

It is an additional feature and advantage of the present invention to provide a device, system and method for conducting a transaction using a translucent, transparent or semitransparent transaction card, which makes use, for example, of a translucent, transparent or semitransparent coating on a surface of the card which absorbs or blocks certain wavelengths of infrared light.

It is a further feature and advantage of the present invention to provide a device, system and method for conducting a transaction using a translucent, transparent or semitransparent transaction card, in which absorption or blocking of certain wavelengths of infrared light enables the card to make its presence known in an electronic device, such as an ATM terminal, into which the card is inserted in order to perform a transaction.

To achieve the stated and other features, advantages and objects, an embodiment of the present invention provides a device, system and method for conducting a transaction, such as a financial transaction, using a uniquely translucent, transparent or semitransparent transaction card, such as a magnetic stripe card or smart card, utilizing a clear transparent material such as clear PVC (or any other similarly clear material suitable for use as a transaction card) for the core of the transaction card, on which printing, such as text and graphics is performed.

A translucent, transparent or semitransparent coating, which acts as an infrared filter, is applied to at least one surface of the clear PVC core. The coating is any suitable material which absorbs or blocks certain infrared wavelengths used in electronic sensing devices for detecting the presence of transaction cards, for example, in ATMs. Alternatively, the material that absorbs or blocks the infrared wavelengths can be applied as a film laminated to the clear PVC core or incorporated or embedded in the clear PVC core itself.

The printing of text and/or graphics on the translucent, transparent or semitransparent PVC transaction card is applied in such a manner, that the translucency, transparency or semitransparency of the card remains substantially intact. It is to be understood that terms, such as “translucent,” “transparent” and “semitransparent” are used herein to refer to transaction cards which simply allow visible light rays to pass, as well as transaction cards that allow transmission of visible light rays so that objects on the other side may be seen.

In order to assure that the translucent, transparent or semitransparent transaction card for an embodiment of the present invention makes its presence known to an electronic device, such as an ATM, an embodiment of the present invention makes use of the translucent, transparent or semitransparent material on or in the transaction card to filter, absorb or block certain wavelengths of infrared light, but the material passes or transmits some or all wavelengths of visible light.

The translucent, transparent, or semitransparent transaction card for an embodiment of the present invention filters, absorbs or blocks certain wavelengths of infrared light according to transaction card industry specifications prescribed and written by the American National Standards Institution (ANSI) and International Standards Organization (ISO). Thus, the electronic card device is able to sense the presence of the translucent, transparent or semitransparent transaction card for an embodiment of the present invention, while the card remains translucent, transparent or semitransparent to some or all wavelengths of visible light.

An embodiment of the present invention provides a transaction card, such as a magnetic stripe card and/or a card embedded with smart card microprocessor, for use with the transaction card sensing device, for example, of a transaction terminal or card embossing equipment, which includes a transaction card core of a material capable of passing at least some wavelengths of visible light, front and back overlaminants of a material also capable of passing at least some wavelengths of visible light applied to the transaction card core, and an infrared filter provided to at least one of the transaction card core, the front overlaminant, and the back overlaminant which is also capable of passing at least some wavelengths of visible light while preventing passage of infrared light in a predetermined range of wavelengths, for example, from at least 750 nanometers up to 1250 nanometers, emitted by an infrared light source of the transaction card sensing device.

The transaction card core is made of a material which is translucent, transparent and/or semitransparent to visible light, such as a clear PVC plastic material, and consists of first and second transaction card core components, such as two sheets of clear PVC plastic material having substantially equal thicknesses laminated to one another. The transaction card core includes one or more surface areas for receiving printing, such as text and/or graphics, on either or both of the front and back surfaces of either or both of the two transaction card core components. In addition, the front and back surfaces of the transaction card core are overlaminated with front and back overlaminants of a material which is also translucent, transparent, and/or semitransparent to visible light, such as clear PVC plastic material, and which also have substantially equal thicknesses.

The infrared filter can take the form of a coating of a material which functions as the infrared filter applied to at least one of the front or back surfaces of either or both of the transaction card core components and/or of either or both of the overlaminants, or a film of the infrared filter material laminated to at least one of the front or back surfaces of either or both of the transaction card core components and/or of either or both of the overlaminants. The infrared filter can also take the form of a material which acts as the infrared filter incorporated or embedded in at least one of the transaction card core component and/or in either or both of the overlaminants.

In a method of using the transaction card for an embodiment of the present invention in the transaction card sensing device, a user is provided with the transaction card and allowed to dip the transaction card in the transaction card sensing device, for example, of a transaction terminal, such as an ATM. The card sensing device is provided with an infrared light emitting source directing infrared light in the predetermined range of wavelengths toward an infrared light sensor of the transaction card sensing device. When the transaction card is dipped in the card sensing device, notwithstanding that the transaction card is translucent, transparent, and/or semitransparent to visible light, the infrared light filter of the transaction card interrupts the passage of infrared light from the infrared light emitting source to the infrared light sensor of the transaction card sensing device. In response to the interruption, the infrared light sensor generates a signal indicative of the presence of the transaction card in the card sensing device.

A system for sensing the transaction card for an embodiment of the present invention with the transaction card sensing device includes the transaction card and the infrared light emitting source for directing infrared light in the predetermined range of wavelengths toward the infrared light sensor spaced from the infrared light emitting source and capable of generating the signal indicative of the presence of the transaction card upon an interruption of the passage of the infrared light from the infrared light emitting source by the infrared filter of the transaction card.

Additional objects, advantages and novel features of the invention will be set forth in part in the description which follows, and in part will become more apparent to those skilled in the art upon examination of the following, or may be learned by practice of the invention.

### BRIEF DESCRIPTION OF THE DRAWINGS

FIG. 1 illustrates a front view of a sample translucent, transparent or semitransparent transaction card for an embodiment of the present invention;

FIG. 2 is a perspective view partly in section of an example of the translucent, transparent or semitransparent transaction card for an embodiment of the present invention;

FIG. 3 is a fragmental enlarged edge view of the translucent, transparent or semitransparent transaction card for an embodiment of the present invention;

FIG. 4 is a schematic diagram which illustrates an example of use of the translucent, transparent or semitransparent transaction card for an embodiment of the present invention in an electronic transaction card sensing device with an infrared light source and an infrared light sensor;

FIG. 5 shows an exploded view of an example of the transaction card components from front to back for an embodiment of the present invention; and

FIG. 6 shows an exploded view of an example of the transaction card components in reverse order from back to front for an embodiment of the present invention.

### DETAILED DESCRIPTION

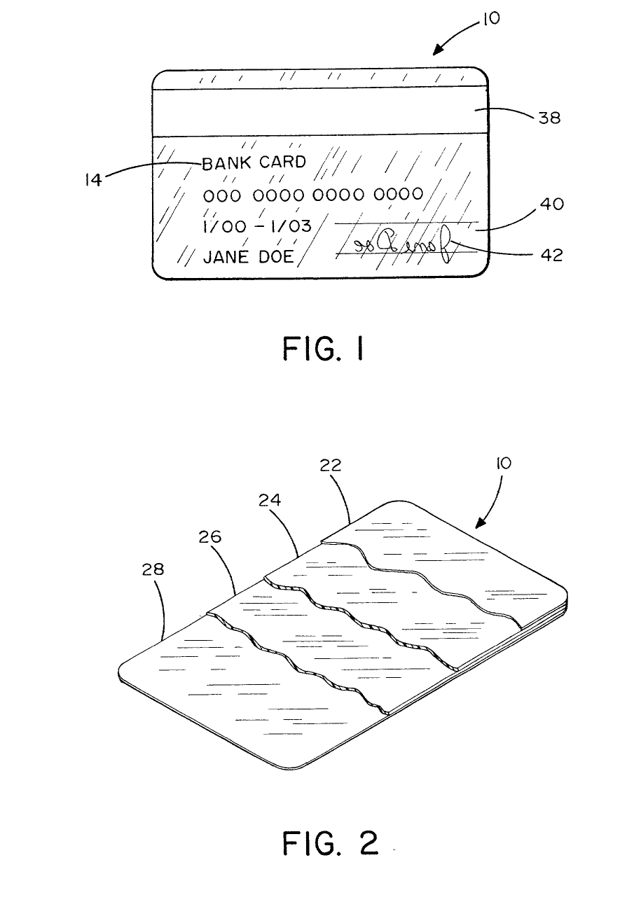

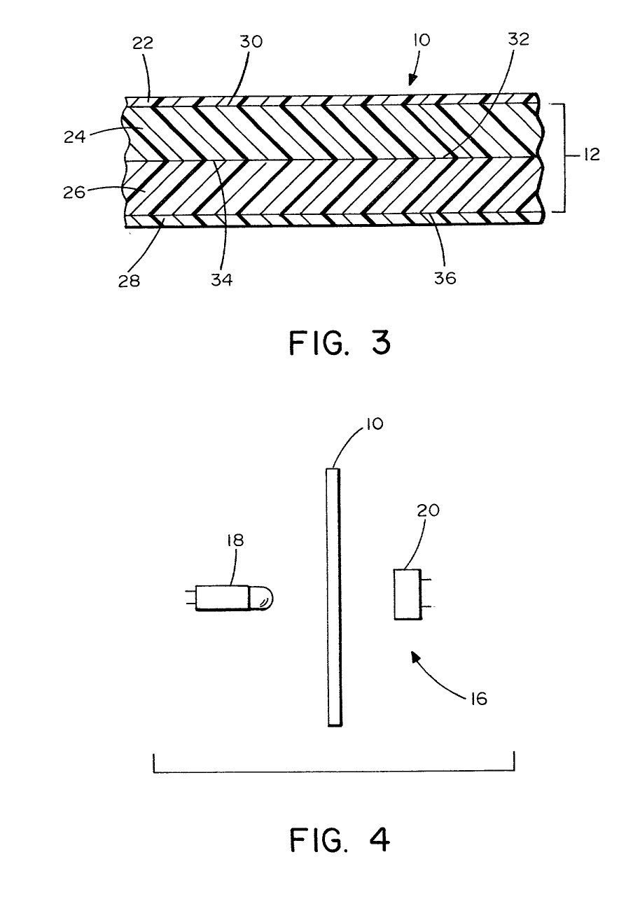

Referring now in detail to an embodiment of the invention, an example of which is illustrated in the accompanying drawings, FIG. 1 illustrates a front view of a sample translucent, transparent or semitransparent transaction card 10 for an embodiment of the present invention, FIG. 2 is a perspective view partly in section of an example of the translucent, transparent or semitransparent transaction card 10 for an embodiment of the present invention, and FIG. 3 is a fragmental enlarged edge view of the translucent, transparent or semitransparent transaction card 10 for an embodiment of the present invention. Referring to FIGS. 1-3, an embodiment of the present invention provides the translucent, transparent or semitransparent transaction card 10 which substitutes a clear transparent core of a material, such as a clear PVC plastic core 12, for the conventional non-transparent white PVC core of the transaction card 10.

Thus, in an embodiment of the present invention, printing 14 on the card 10, such as text or graphics, is performed on the clear PVC core 12 rather than on a conventional white PVC core. However, the printing 14 is done on the clear PVC core 12 in such a fashion that the translucency, transparency or semitransparency of the transaction card 10 remains substantially intact. While all areas of the transaction card 10 may obviously not be totally translucent, transparent or semitransparent after printing with text or graphics, the card 10 retains most of its translucent, transparent or semitransparent look when held up to light, even after the printing 14.

FIG. 4 is a schematic diagram which illustrates an example of use of the translucent, transparent or semitransparent transaction card 10 for an embodiment of the present invention in an electronic transaction card sensing device 16 with an infrared light source 18 and an infrared light sensor 20. In order to assure that the translucent, transparent or semitransparent transaction card 10 makes its presence known to an electronic card device 16, an embodiment of the present invention includes adding a predefined degree of infrared filtering, absorption or blocking property to at least predetermined areas of the card 10 to instruct the electronic card device 16 that there is a usable transaction card 10 in the device 16. The levels of infrared filtering, absorption or blocking are at least equal to or greater than necessary to conform to the transaction card industry specifications or standards. The transaction card industry specifications or standards are those prescribed and written by the American National Standards Institution or ANSI, as well as by the International Standards Organization or ISO.

Referring further to FIG. 4, the electronic card device 16 is able to sense the presence of the translucent, transparent, or semitransparent transaction card 10 for an embodiment of the present invention using, for example, an infrared light sensor 20, that look for the presence of the card. There are numerous different types of ATM card readers, many of which follow the ISO and ANSI standards as to where the sensor 20 is located and what type of sensor is used, such as the infrared sensor 20, visible light sensors, or mechanical sensing means, but all ATM card readers do not necessarily follow the industry standards.

An embodiment of the present invention provides a translucent, transparent or semitransparent transaction card 10 for use with an electronic card device 16 which uses, for example, infrared light. The transaction card 10 passes or transmits all or some wavelengths of visible light but is coated with or incorporates an infrared filtering, absorbing or blocking material which makes the card device 16 believe or know that there is a card in the device. This is accomplished because at least some of the infrared light from the light emitting source 18 of the card device 16 does not pass through from one side of the transaction card 10 to the sensor receiver 20 of the device 16 on the other side of the card 10.

As shown in FIGS. 2 and 3, the transaction card 10 for an embodiment of the present invention consists, for example, of four layers 22, 24, 26, 28. According to industry standards, a typical credit card cannot be greater than 33 mils or less than 27 mils in thickness. The transaction card industry uses a process known as “split core,” in which the inside materials or core of the card consist of two separate pieces of material, for example, plastic material, such as PVC. Currently, these two pieces of plastic consist of completely opaque white PVC, each of which is 13½ mils in thickness.

An embodiment of the present invention makes use, for example, of two pieces or sheets 24, 26 of transparent material, such as clear PVC, each, for example, 13½ mils thick, for the core 12. On top of those two pieces or sheets 24, 26 are laminated, for example, a two mil overlaminant 22 of clear plastic on the front and another two mil overlaminant 28 of clear plastic on the back of the core 12. In other words, the two pieces or sheets 24, 26 of transparent PVC inner core or split core materials, 13½ mils each, are joined together to form a core 12, for example, 27 mils thick. This core 12 is then overlaminated with the clear or transparent plastic overlaminants 22, 28 to form a transaction card 10 that is, for example, about 30 mils thick.

On currently available non-transparent transaction cards, all imaging, typography and the like are printed only on two printing surfaces, namely, the front and back exposed outer surfaces of the white PVC inner core, after the split core components are joined together. However, in an embodiment of the present invention, imaging, typography and the like can be printed on one or both of the front and back surfaces of both of the transparent PVC split core components before they are joined together. Thus, an embodiment of the present invention provides four printing surfaces, instead of only two printing surfaces.

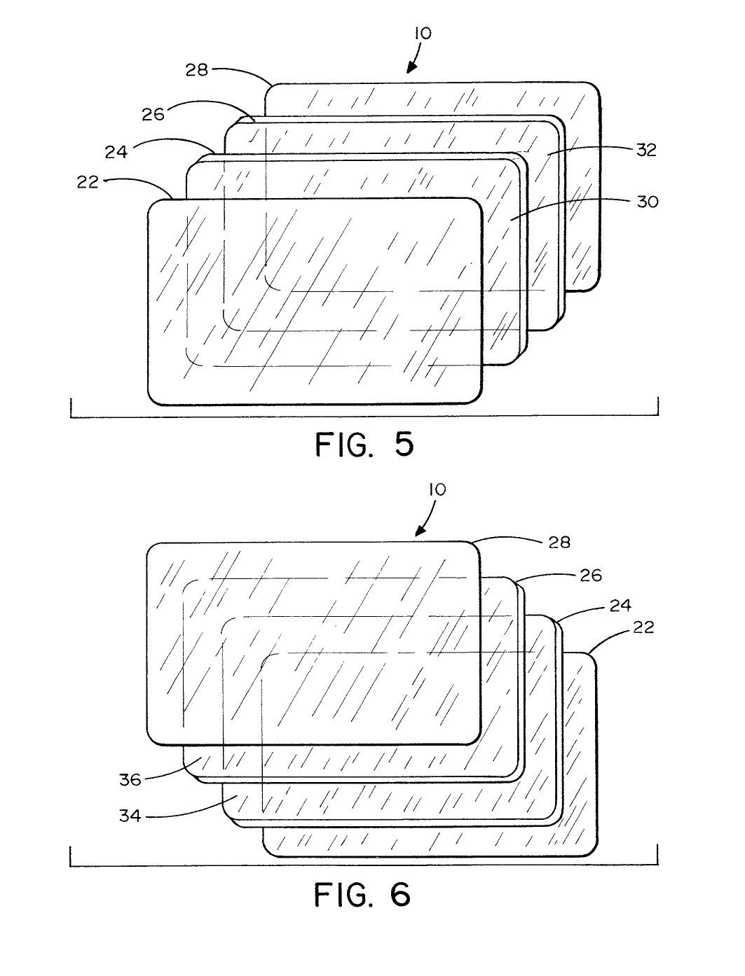

FIG. 5 shows an exploded view an example of the transaction card components from front to back for an embodiment of the present invention, and FIG. 6 shows an exploded view an example of the transaction card components in reverse order from back to front for an embodiment of the present invention. Referring to FIGS. 3 and 5, printing and graphics can be applied to the front surface 30 of transparent PVC core component 24 and the front surface 32 of core component 26, and referring to FIGS. 3 and 6, printing and graphics can be applied to back surface 34 of core component 24 and the back surface 36 of core component 26.

An embodiment of the present invention provides a transaction card 10 that is basically translucent, transparent or semitransparent and makes use of a clear PVC, or a standard clear PVC, for the card and an infrared blocking or absorbing dye that is applied via printing, for example, onto one of the surfaces of the card and then encapsulated in between the layers of plastic. Printing and graphics can then be applied. The dye can be any suitable material which passes visible light and acts as an infrared filter and which, for example, absorbs or blocks a predetermined range of infrared wavelengths, such as infrared wavelengths in the 750 to 1250 nanometer range. Alternatively, the material that passes visible light and absorbs or blocks the infrared wavelengths can be applied as a laminated film or incorporated or embedded in the card itself.

An important aspect of an embodiment of the present invention is the absorption or blocking of infrared wavelengths in a range in which transaction card sensing devices of ATMs, such as the sensing device 16 of FIG. 4, operate to detect the presence of a transaction card 10. The material is a dye substratum with any suitable chemical composition that is translucent, transparent or semitransparent and which performs the function of infrared blocking. As used herein, the term “dye” refers to an infrared blocking or absorbing material that is transparent or translucent which is incorporated in or applied to a surface of the transaction card 10 and is not limited to a coloring material, although it may be tinted a color, such as yellow and/or green. One example of a suitable material is an infrared absorbing or blocking dye furnished by Perfect Plastics Printing Corporation of St. Charles, Ill.

In an embodiment of the present invention, the infrared absorbing or blocking dye substratum is applied, for example, in between the two clear PVC core substrates or layers 24, 25 of the transaction card 10. In that way, printing and graphics can be applied to areas of the outer surfaces 30, 36 of the transaction card 10 using standard transaction card printing methods and standard transaction card inks of various colors or combinations of colors. While the ink that is used for applying printing or graphics on areas of the outer surfaces 30, 36 of the transaction card 10 may block or absorb varying levels of infrared light in certain wavelength ranges in the particular areas to which printing or graphics are applied, the printing ink is not necessarily effective for detection of the presence of the translucent, transparent of semitransparent transaction card 10 by the infrared card sensing device 16.

The infrared card sensing device 16, especially in a typical ATM, operates within a particular range of wavelengths of the infrared spectrum, and the printing ink absorbs some wavelengths but does not necessarily block enough infrared light to be effective for detecting the translucent, transparent of semitransparent transaction card 10. Thus, in an embodiment of the present invention, a translucent, transparent or semitransparent coating 10 of infrared filtering, absorbing or blocking dye is applied over the entire area, for example, of the surface 30 and/or 36 of the card 10, thereby eliminating any possibility of leakage of any infrared light that could interfere with the detection of the card 10 by the card detecting device 16.

In an aspect of an embodiment of the present invention, the dye coating which filters, absorbs or blocks infrared light is applied over an entire surface 30 and/or 36 of the translucent, transparent of semitransparent transaction card 10. An aspect of an embodiment of the present invention is that the coating is not necessarily visible to the naked eye. However, another aspect of an embodiment of the present invention is use of a coating that is tinted a certain color, such as a yellow tint, and the addition or subtraction of one or more colors to achieve a coating that appears clear or transparent to the naked eye.

In an embodiment of the present invention, the coating which filters, absorbs or blocks certain wavelengths of infrared light, at the same time, passes all or certain wavelengths of visible light. In other words, while the coating passes or transmits visible light, it blocks or absorbs a predefined range of wavelengths of infrared light, such as the infrared range of 750 to 1250 nanometers that the sensing device 16 of an ATM normally uses, so that the sensing device 16 looks at the card 10 and perceives that a full white core transaction card product has been inserted into the ATM.

Another aspect of an embodiment of the present invention is use of the translucent, transparent or semitransparent transaction card 10 in transaction card embossing equipment. While sensing devices of all card embossing equipment do not necessarily meet the typical ISO specifications for ATM transaction cards, it has been found that the translucent or transparent transaction card 10 for an embodiment of the present invention functions equally as well in the sensing device 16 of certain card embossing equipment.

The translucent, transparent of semitransparent transaction card 10 for an embodiment of the present invention can be used in a transaction terminal, such as an ATM, as well as with other equipment, such as card embossing equipment, with the card sensing device 16 that makes use of the infrared light emitting source 18 directing infrared light in the predetermined range of wavelengths toward the infrared light sensor 20. A user, for example, dips the transaction card 10 in the card sensing device 16 of a transaction terminal, such as an ATM. The transaction card 10, which consists of a translucent, transparent, or semitransparent PVC plastic core 12 that allows the passage of at least some wavelengths of visible light while preventing the passage of infrared light in the predetermined range of wavelengths, interrupts the passage of infrared light from the infrared light emitting source 18 to the infrared light sensor 20 of the transaction card sensing device. In response to the interruption, the transaction card sensing device 16 sends a signal to a processor (not shown) of the transaction terminal indicating the presence of the transparent transaction card 10.

In an embodiment of the present invention, the infrared filtering or absorbing coating is applied to the entire surface 30, 32, 34, and/or 36 of one or both of the two clear PVC pieces or sheets 24, 26 of the sandwich 12 that make up the translucent, transparent or semitranslucent transaction card 10. An embodiment of the present invention makes use of any suitable material or component which is added or included in the coating or the card itself that has the property of absorbing or filtering a predefined range of infrared light wavelengths, and that also has the property of passing some or all visible or optical light, such that the transaction card 10 is translucent, transparent or semitransparent to the naked eye.

In an embodiment of the present invention, the coating material is characterized, for example, as a chemical film that is liquid and applied to a surface of the transaction card 10 via a printing process, such as screen or offset printing. The coating material is a chemical composition which bonds to plastic, such as PVC, in a manner similar to which the ink that is used to apply printing and graphics to the transaction card 10 bonds with the plastic. Alternatively, the material can be incorporated or embedded in one or more of the clear PVC components 22, 24 of the transaction card 10 itself or applied as a film 22, 28 laminated to one or more of the PVC components 22, 24 of the transaction card 10.

In an embodiment of the present invention, while an entire surface, such as the entire front surface 30, 32 or the entire back surface 34, 36 of one of the two clear PVC sandwich members 24, 26 that make up the transaction card 10, is coated, an alternative aspect is application of the coating to preselected areas in spots or sections of a surface of the card 10. However, it has been found that the sensing devices of certain ATMs are indiscriminate in where they look for the presence of the transaction card 10. For example, while the sensing devices of many ATMs look to certain top and bottom areas of the transaction card 10 according to industry standards, other ATMs look down the exact center of the card 10 as well.

In an embodiment of the present invention, an entire surface 30, 32, 34, and/or 36 of the card 10 is coated in order to assure usefulness in all ATMs, whether or not the ATMs follow industry standards. However, in the alternative aspect, the card 10 can be coated in preselected spots, sections or areas. For example, if it is desired that only the middle of the card 10 is clear, the card 10 can be spot printed with the coating material, and the rest of the card 10 can be opaqued with ink. Fundamentally, an embodiment of the present invention provides a transaction card 10 that is optically clear but is completely covered with an infrared filter.

Referring again to FIG. 1, the translucent or transparent transaction card 10 for an embodiment of the present invention can be provided, for example, with one or both of a standard magnetic stripe 38 or an embedded smart card microchip (not shown) which is not necessarily translucent or transparent. The translucent, transparent, or semitransparent transaction card 10 for an embodiment of the present invention can likewise be provided with a signature strip or panel 40. Typically, signature panels are branded by the various card associations. An aspect of an embodiment of the present invention includes, for example, a transparent signature stripe or panel 40, such that the signature 42 is visible through the translucent, transparent or semitransparent transaction card 10 from either the front or the back of the card 10 as shown in FIG. 1.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A transaction card for use with a transaction card sensing device, comprising:
a transaction card core of a material capable of passing at least some wavelengths of visible light;
front and back overlaminants of a material also capable of passing at least some wavelengths of visible light applied to the transaction card core; and
an infrared filter provided to at least one of the transaction card core, the front overlaminant, and the back overlaminant which is capable of passing at least some wavelengths of visible light while preventing passage of infrared light in a predetermined range of wavelengths emitted by an infrared light source of the transaction card sensing device.

2. The transaction card of claim 1, wherein the transaction card core further comprises a material which is at least one of translucent, transparent and semitransparent to visible light.

3. The transaction card of claim 1, wherein the transaction card core material further comprises a clear polyvinyl chloride plastic material.

4. The transaction card according to claim 1, wherein the transaction card core further comprises first and second transaction card core components laminated to one another.

5. The transaction card of claim 4, wherein the first and second transaction card core components further comprise first and second sheets of clear polyvinyl chloride plastic material laminated to one another.

6. The transaction card of claim 5, wherein the first and second sheets of clear polyvinyl chloride plastic material further comprise first and second sheets of clear polyvinyl chloride plastic material having substantially equal thicknesses laminated to one another.

7. The transaction card of claim 1, wherein the transaction card core further comprises a surface area for receiving printing.

8. The transaction card of claim 7, wherein the surface area for receiving printing further comprises an area of at least one of a front surface and a back surface of at least one of a first and a second transaction card core component.

9. The transaction card of claim 1, wherein the front and back overlaminants further comprise a material which is at least one of translucent, transparent, and semitransparent to visible light.

10. The transaction card of claim 1, wherein the front and back overlaminants further comprise a front overlaminant of a clear polyvinyl chloride plastic material laminated to a front surface of the transaction card core and a rear overlaminant of a clear polyvinyl chloride plastic material laminated to a back surface of the transaction card core.

11. The transaction card of claim 10, wherein the front and back overlaminants of clear the polyvinyl chloride plastic material further comprise front and back overlaminants of the clear polyvinyl chloride plastic material having substantially equal thicknesses.

12. The transaction card of claim 1, wherein the infrared filter further comprises a coating of a material which functions as the infrared filter applied to at least one of a front surface and a back surface of at least one of a first and a second transaction card core component, the front overlaminant, and the back overlaminant.

13. The transaction card of claim 1, wherein the infrared filter further comprises a film of a material which functions as the infrared filter laminated to at least one of a front surface and a back surface of at least one of a first and a second transaction card core component, the front overlaminant, and the back overlaminant.

14. The transaction card of claim 1, wherein the infrared filter further comprises a material which acts as the infrared filter incorporated in at least one of a first and a second transaction card core component, the front overlaminant, and the back overlaminant.

15. The transaction card of claim 1, wherein the infrared filter further comprises a material which acts as the infrared filter embedded in at least one of a first and a second transaction card core component, the front overlaminant, and the back overlaminant.

16. The transaction card of claim 1, wherein the infrared filter further comprises a material capable of passing at least some wavelengths of visible light while preventing passage of infrared light in the predetermined range of wavelengths from at least 750 nanometers up to 1250 nanometers.

17. The transaction card of claim 1, further comprising a magnetic stripe applied to the transaction card core.

18. The transaction card of claim 1, further comprising a smart card microprocessor embedded in the transaction card core.

19. A method of using a transaction card in a transaction card sensing device, comprising:
providing a user with a transaction card of a material capable of passing at least some wavelengths of visible light and having an infrared filter capable of passing at least some wavelengths of visible light while preventing passage of infrared light in a predetermined range of wavelengths;
allowing the user to dip the transaction card in the transaction card sensing device provided with an infrared light emitting source directing infrared light in the predetermined range of wavelengths toward an infrared light sensor of the transaction card sensing device;
interrupting the passage of infrared light from the infrared light emitting source to the infrared light sensor of the transaction card sensing device by the infrared filter of the dipped transaction card; and
generating a signal by the infrared light sensor in response to the interruption indicative of the presence of the transaction card in the card sensing device.

20. The method of claim 19, wherein providing the user with the transaction card further comprises providing the user with the transaction card having a transaction card core of a material which is at least one of translucent, transparent, and semitransparent to visible light.

21. The method of claim 19, wherein providing the user with the transaction card further comprises providing the user with the transaction card having a transaction card core of a clear polyvinyl chloride plastic material.

22. The method of claim 21, providing the user with the transaction card further comprises providing the user with the transaction card having the transaction card core of first and second core components of the clear polyvinyl chloride plastic material laminated to one another.

23. The method of claim 22, wherein providing the user with the transaction card further comprises providing the user with the transaction card having the transaction card core of first and second sheets of clear polyvinyl chloride plastic having substantially equal thicknesses laminated to one another.

24. The method of claim 20, wherein providing the user with the transaction card further comprises providing the user with the transaction card having the transaction card core with a surface area for receiving printing on an area of at least one of a front surface and a back surface of at least one of a first and a second transaction card core component.

25. The method of claim 20, wherein providing the user with the transaction card further comprises providing the user with the transaction card having front and back overlaminants of a material which is also at least one of translucent, transparent, and semitransparent to visible light applied to the transaction card core.

26. The method of claim 25, wherein providing the user with the transaction card further comprises providing the user with the transaction card having the front overlaminant of a clear polyvinyl chloride plastic material laminated to a front surface of the transaction card core and the back overlaminant of the clear polyvinyl chloride plastic material laminated to a back surface of the transaction card core.

27. The method of claim 19, wherein providing the user with the transaction card further comprises providing the user with the transaction card having a transaction card core and front and back overlaminants, at least one of which is provided with the infrared filter.

28. The method of claim 27, wherein providing the user with the transaction card further comprises providing the user with the transaction card having the transaction card core and front and back overlaminants, at least one surface of at least one of which has a coating of a material which functions as the infrared filter.

29. The method of claim 27, wherein providing the user with the transaction card further comprises providing the user with the transaction card having the transaction card core and front and back overlaminants, to at least one surface of at least one of which is laminated a film of a material which functions as the infrared filter.

30. The method of claim 27, wherein providing the user with the transaction card further comprises providing the user with the transaction card having the transaction card core and front and back overlaminants, at least one of which incorporates a material which functions as the infrared filter.

31. The method of claim 27, wherein providing the user with the transaction card further comprises providing the user with the transaction card having the transaction card core and front and back overlaminants, at least one of which is embedded with a material which acts as the infrared filter.

32. A system for sensing a transaction card with a transaction card sensing device, comprising:
a transaction card having an infrared filter and capable of passing at least some wavelengths of visible light while preventing passage of infrared light in a predetermined range of wavelengths; and
an infrared light emitting source for directing infrared light in the predetermined range of wavelengths toward an infrared light sensor spaced from the infrared light emitting source and capable of generating a signal indicative of the presence of the transaction card upon an interruption of the passage of the infrared light from the infrared light emitting source by the infrared filter of the transaction card.

33. The system of claim 32, wherein the transaction card further comprises a transaction card core of a material capable of passing at least some wavelengths of visible light.

34. The system of claim 33, wherein the transaction card further comprises front and back overlaminants of a material also capable of passing at least some wavelengths of visible light applied to the transaction card core.

35. The system of claim 34, wherein the transaction card further comprises the infrared filter provided to at least one of the transaction card core, the front overlaminant, and the back overlaminant and which is capable of passing at least some wavelengths of visible light while preventing passage of infrared light in the predetermined range of wavelengths.

36. The system of claim 33, wherein the transaction card core further comprises a material which is at least one of translucent, transparent and semitransparent to visible light.

37. The system of claim 36, wherein the transaction card core material further comprises a clear polyvinyl chloride plastic material.

38. The system of claim 33, wherein the transaction card core further comprises first and second transaction card core components laminated to one another.

39. The system of claim 38, wherein the first and second transaction card core components further comprise first and second sheets of a clear polyvinyl chloride plastic material laminated to one another.

40. The system of claim 39, wherein the first and second sheets of clear polyvinyl chloride plastic material further comprise first and second sheets of clear polyvinyl chloride plastic material having substantially equal thicknesses laminated to one another.

41. The system of claim 33, wherein the transaction card core further comprises a surface area for receiving printing.

42. The system of claim 41, wherein the surface area for receiving printing further comprises an area of at least one of a front surface and a back surface of at least one of a first and a second transaction card core component.

43. The system of claim 34, wherein the front and back overlaminants further comprise a material which is at least one of translucent, transparent, and semitransparent to visible light.

44. The system of claim 34, wherein the infrared filter further comprises a coating of a material which functions as the infrared filter applied to at least one of a front surface and a back surface of at least one of a first and second transaction card core component, the front overlaminant, and the back overlaminant.

45. The system of claim 34, wherein the infrared filter further comprises a film of a material which acts as the infrared filter laminated to at least one of a front surface and a back surface of at least one of a first and second transaction card core component, the front overlaminant, and the back overlaminant.

46. The system of claim 34, wherein the infrared filter further comprises a material which functions as the infrared filter incorporated in at least one of a first and second transaction card core component, the front overlaminant, and the back overlaminant.

47. The system of claim 43, wherein the infrared filter further comprises a material which functions as the infrared filter embedded in at least one of a first and second transaction card core component, the front overlaminant, and the back overlaminant.

48. The system of claim 32, wherein the infrared filter further comprises a material capable of passing visible light while preventing passage of infrared light in a predetermined range of wavelengths from at least 750 nanometers up to 1250 nanometers.

49. The system of claim 32, further comprising magnetic stripe applied to the transaction card.

50. The system of claim 32, further comprising a smart card microprocessor embedded in the transaction card.
